(19) United States
(12) Patent Application Publication
(10) Pub. No.: US 2017/0323335 A1
(43) Pub. Date: Nov. 9, 2017

(54) METHOD FOR ADVERTISING OR SELLING PRODUCTS ON BASIS OF USER'S SOCIAL NETWORK SERVICE ACTIVITY

(71) Applicant: 08LITER CORP., Seoul (KR)

(72) Inventor: Changwoo CHOI, Seoul (KR)

(73) Assignee: 08LITER CORP., Seoul (KR)

(21) Appl. No.: 15/662,467

(22) Filed: Jul. 28, 2017

Related U.S. Application Data
(63) Continuation of application No. PCT/KR2016/001322, filed on Feb. 5, 2016.

(30) Foreign Application Priority Data
Oct. 30, 2015 (KR) 10-2015-0152322

(51) Int. Cl. G06Q 30/02; G06Q 50/00; H04L 29/08

(52) U.S. Cl. CPC G06Q 30/0255; G06Q 50/01; G06Q 30/0269; H04L 67/22

(57) ABSTRACT

Provided is a method for advertising a product on the basis of a social network service activity of a user comprises posting, by an operation server, information on a product online for a predetermined time period; receiving an experience application for the product, through a user device of each user, from at least one user who has registered in the operation server with SNS interworking information for interworking with at least one SNS server; selecting at least one person to experience the product who will promote the product from among the users who have applied for the experience according to a predetermined condition when the predetermined time elapses; and providing the product to the person to experience the product and requesting the user device to share the review information related to the product with another user in an SNS server registered by the person to experience the product.

### CROSS-REFERENCE TO RELATED APPLICATIONS

The present application is a continuation of International Patent Application No. PCT/KR2016/001322, filed Feb. 5, 2016, which is based upon and claims the benefit of priority to Korean Patent Application No. 10-2015-0152322, filed on Oct. 30, 2015. The disclosures of the above-listed applications are hereby incorporated by reference herein in their entirety.

### BACKGROUND

Embodiments of the inventive concept described herein relate to a method for advertising or selling products based on social network service (SNS) activities of users.

Recently, with the development of communication technologies, there has been a steadily growing trend towards a market scale of electronic commerce. A purchaser may purchase a product in an online shopping mall which is a virtual space over a network without directly visiting an offline store.

Meanwhile, an online shopping mall or the like may entice customers through a separate promotion method using a variety of marketing schemes. Since a purchaser is limited online to directly seeing and touching a product, properly promoting the product may be important as much as selling the product.

As this advertisement for the product, an operator may guide a consumer who purchases the product to directly post a review for the product on an Internet site of the operator and may advertise the product.

An advertising range may be limited in a conventional manner of directly advertising a product online by a product seller. Particularly, since it is difficult for a general consumer to recognize a sales site or the like of an unknown company or the like, an advertisement may fail to be efficiently performed.

Further, in a manner of directly writing a review on the sales site by the product seller, the review may be recognized as information which is distorted or unreliable in view of another consumer. The consumer should still know an address of a sales site or the like to view this review.

### SUMMARY

Embodiments of the inventive concept provide an advertising method for naturally and excessively propagating an advertisement by selecting users to advertise a product among users who use an SNS, providing the product to the selected users, and advertising the product using SNS activities of the users.

Embodiments of the inventive concept provide a method for providing profits to both of a provider and a consumer by selling a product with a discounted amount to a user on a condition of an SNS activity of the user.

According to an aspect of an embodiment, a method for advertising a product based on a social network service (SNS) activity of a user, the method comprises posting, by an operation server, information about the product online during a time, receiving, by the operation server, an application for experiencing the product via a user device of each of at least one or more users from the at least one or more users who register SNS interworking information for interworking with at least one SNS server in the operation server, if a time elapses, determining, by the operation server, at least one or more persons to experience the product to promote the product among users who applies for experiencing the product according to a condition, providing, by the operation server, the product to the persons to experience the product and requesting, by the operation server, the user device to share review information associated with the product with another user on an SNS server in which the persons to experience the product are registered, the review information including hashtag information associated with the product and photo information including the product, receiving, by the operation server, SNS activity information collected from the SNS server during a time period with respect to the review information from the SNS server, configuring, by the operation server, content of the persons to experience the product, based on at least one of the review information, SNS activity information of the persons to experience the product, and user information of the persons to experience the product, the user information being registered in the operation server, outputting, by the operation server, a widget generation editing tool for generating a widget through a product provider device based on the configured content, generating and outputting, by the operation server, source information for outputting a processed widget on a preview screen and a webpage of the widget generated by processing the content, based on an input of the product provider device on the widget generation editing tool, and providing, by the operation server, the output source information to the product provider device.

According to another aspect of an embodiment, a method for selling a product based on an SNS activity of a product purchaser, the method comprises receiving, by an operation server, discount price information generated by subtracting an SNS advertising price information value calculated as an SNS advertising cost from consumer price information for the product from a product provider device, posting, by the operation server, information about the product including the discount price information online, receiving, by the operation server, an application for purchasing the product via a user device of each of at least one or more users from the at least one or more users who register SNS interworking information for interworking with at least one SNS server in the operation server, if a purchase amount corresponding to the discount price information is paid from the user, paying, by the operation server, a sale amount in which a fee for each product is excepted from the purchase amount to a product provider, providing, by the operation server, the product to a user who pays the sale amount and requesting, by the operation server, the user device to share review information associated with the product with another user on an SNS server in which the user is registered, the review information including hashtag information associated with the product and photo information including the product, receiving, by the operation server, SNS activity information collected from the SNS server during a time period with respect to the review information from the SNS server, configuring, by the operation server, content of persons to experience the product based on at least one of the review information, SNS activity information of the persons to experience the product, and user information of persons to experience the product, the user information being registered in the operation server, outputting, by the operation server, a widget generation editing tool for generating a widget through a product provider device based on the configured content, generating and outputting, by the operation server, source information for outputting a processed widget on a preview screen and a webpage of the widget generated by processing the content, based on an input of the product provider device on the widget generation editing tool, and providing, by the operation server, the output source information to the product provider device.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram illustrating a schematic configuration of a system which operates a method for advertising or selling a product based on an SNS activity of a user according to various embodiments of the inventive concept;

FIG. 2 is a signal sequence diagram illustrating a service subscription operation of a user at an operation server according to various embodiments of the inventive concept;

FIG. 3 is a drawing illustrating an operation where an operation server and an SNS server in which a user is registered interwork with each other according to various embodiments of the inventive concept;

FIG. 4 is a flowchart illustrating a method for advertising a product according to various embodiments of the inventive concept;

FIG. 5 is a signal sequence diagram illustrating a detailed method for advertising a product according to various embodiments of the inventive concept;

FIG. 6 is a drawing illustrating an operation in which an operation server displays a screen where a product application is received during a time through a webpage in a method for advertising a product according to various embodiments of the inventive concept;

FIG. 7 is a drawing illustrating review information about a product posted on an SNS server in a method for advertising the product according to various embodiments of the inventive concept;

FIG. 8 is a drawing illustrating a review information screen of a product registered in an operation server in a method for advertising the product according to various embodiments of the inventive concept;

FIG. 9A is a drawing illustrating content of the best person to experience a product for each product in a method for advertising the product according to various embodiments of the inventive concept;

FIG. 9B is a drawing illustrating an operation of providing a screen associated with content of the best person to experience a product in a method for advertising the product according to various embodiments of the inventive concept;

FIG. 10 is a flowchart illustrating a method for selling a product according to various embodiments of the inventive concept;

FIG. 11 is a flowchart illustrating an operation where a user interests and registers a brand of a specific product provider in a method for advertising or selling a product according to various embodiments of the inventive concept;

FIG. 12 is a drawing illustrating a menu screen where a user interests and register a brand of a specific product provider;

FIG. 13 is a drawing illustrating a screen of sorting product information relative to a brand of a specific product provider;

FIG. 14 is a drawing illustrating a screen where a brand a user interests and registers is displayed on a user information menu;

FIG. 15 is a drawing illustrating a widget generation editing tool provided from an operation server to a product provider according to various embodiments of the inventive concept; and

FIG. 16 is a drawing illustrating an operation where a product provider uses a widget generated in FIG. 15 in a web site of a product provider.

### DETAILED DESCRIPTION

Advantages, features, and methods of accomplishing the same will become apparent with reference to embodiments described in detail below together with the accompanying drawings. However, the inventive concept is not limited by embodiments disclosed hereinafter, and may be implemented in various forms. Rather, these embodiments are provided to so that this disclosure will be through and complete and will fully convey the concept of the invention to those skilled in the art, and the inventive concept will only be defined by the appended claims.

Unless otherwise defined herein, all terms (including technical and scientific terms) used in the specification may have the same meaning that is generally understood by a person skilled in the art. Also, terms which are defined in a dictionary and commonly used should be interpreted as not in an idealized or overly formal detect unless expressly so defined.

The term “SNS” described herein may be a social network service and may be a service for reinforcing social relationships with acquaintances, such as friends, seniors and juniors, and colleagues, on a web, building new personal connections, and establishing a wide human network. According to various embodiments of the inventive concept, the SNS may include, for example, Facebook™, KakaoStory™, Twitter™, Instagram™, or the like. Herein, embodiments are not limited thereto. The SNS according to various embodiments of the inventive concept may be collectively called various types of services which belong to a social network service. In addition, an SNS server used in the specification may include an SNS server operated in various countries without being limited to a specific country.

Further, the term “SNS interworking information” described herein may refer to information necessary for recognizing or interworking with an SNS server used by a user. According to various embodiments, the SNS interworking information may refer to the SNS server itself (e.g., KakaoTalk™, Facebook™ Instagram™, or the like) to interwork with an operation server according to various embodiments of the inventive concept.

Further, the term “user” described in the specification may be called a user which register as a member on a webpage provided from an operation 100 via a user device 300, requests to experience or purchase a product, and uses at least one SNS. Further, in a method for advertising a product, a user before being determined as a person to experiences the product may be described as being replaced with an “applicant”. Further, a user determined as the person to experience the product may be described as being in parallel with the person to experience the product or a social editor. Herein, the social editor may refer to a user who edits a post for a product using hashtag information, photo information, or the like on an SNS server to naturally advertise the product. In other words, the social editor and the person to experience the product may be used as the same meaning in the specification.

Further, the term “SNS activity information of an applicant” described herein may be SNS activity information of a user, collected to determine a person to experience the product. Meanwhile, the term “SNS activity information of a person to experience a product” or “SNS activity information of a social editor” may be SNS activity information of a user, collected during a time period when a user selected as the person to experience the product shares review information with another user on an SNS. Thus, the SNS activity information may include a variety of information according to a definition described below and may classified as SNS activity information before or after being determined as the person to experience the product.

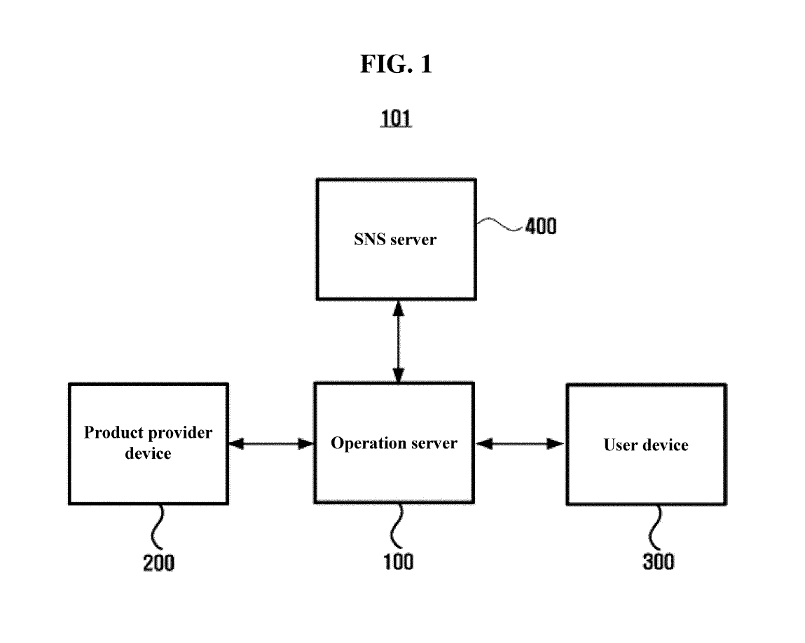

FIG. 1 is a block diagram illustrating a configuration of a system 101 which provides a method for advertising or selling a product based on an SNS activity of a user according to an embodiment of the inventive concept. The system 101 may include an operation server 100, a product provider device 200, a user device 300, and an SNS server 400. According to various embodiments, the system 101 may fail to include at least one of the elements of FIG. 1 or may further include other element(s).

In the system 101 having the above-mentioned elements, the operation server 100 may receive a request to advertise a product from the product provider 200 and may provide the product to a user determined as a person to experience the product among users who subscribe to the operation server 100, thus requesting the user device 300 to perform an SNS advertisement activity for the product.

Further, in the system 101, the operation server 100 may receive discount price information from the product provider device 200 and may provide the product to the user in an amount corresponding to the discount price information on a condition of SNS activity information of the user.

First of all, the operation server 100 may be a platform which requests the user to perform an advertisement activity based on a social network and may provide a function of acting as a go-between between a product provider and the user and supporting the user in promoting the product on an SNS. Such an operation server 100 may be implemented with hardware, software, or firmware which may communicate with the product provider device 200 and the user device 300 directly or over a network (e.g., the Internet or the like) to transmit/receive information.

According to various embodiments, the operation server 100 may include a display unit (e.g., a display module or a touch screen), an input unit (e.g., a physical key, a virtual key, or a touch screen), a storage unit (e.g., a memory), a communication unit (e.g., a radio frequency (RF) receiving unit, an RF transmitting unit, or a transceiver), and a controller (e.g., a processor). The operation server 100 may fail to include at least one of such elements or may further include other element(s).

For example, the communication unit of the operation server 100 may connect the operation server 100 with at least one of the product provider device 200, the user device 300, and the SNS server 400.

Further, the storage unit of the operation server 100 may include information associated with a product, SNS activity information of an applicant, SNS activity information of a person to experience the product, SNS interworking information, promotion request information of a product provider, user information, brand information of the product provider, discount price information of the product, selection rate information of the person to experience the product, and the like.

An operation of the operation server 100 in FIGS. 1 to 14 which will be described below may be performed by the controller (e.g., the processor) of the operation server 100. According to various embodiments, the memory of the operation server 100 may include instructions (e.g., commands), when executed, for causing the controller of the operation server 100 to perform operations of the operation server 100 described with reference to FIGS. 1 to 14. In addition, such instructions may be stored in a computer-recordable storage medium as well as the memory.

The product provider device 200 may be an electronic device used by a provider to request a product and request to advertise or sell the product. The product provider device 200 may include at least one of a smartphone, a tablet, a mobile phone, a desktop personal computer (PC), a laptop PC, a netbook computer, a workstation, a personal digital assistant (PDA), a portable multimedia player (PMP), an MPEG-1 audio layer 3 (MP3) player, a server, or a wearable device.

The user device 300 may be an electronic device used by the user according to an embodiment and may include at least one of a smartphone, a tablet, a mobile phone, a desktop PC, a laptop PC, a netbook computer, a workstation, a PDA, a PMP, an MP3 player, a server, or a wearable device to be the same those of the product provider device 200.

The SNS server 400 may be a server for managing and operating an SNS used by the user and may be a system for processing a series of functions which provide a service associated with social networking. Such an SNS server 400 may be a device or network for operating, for example, Facebook™, KakaoStory™ Twitter™, or Instagram™ and may be implemented in the form of hardware, software, or firmware.

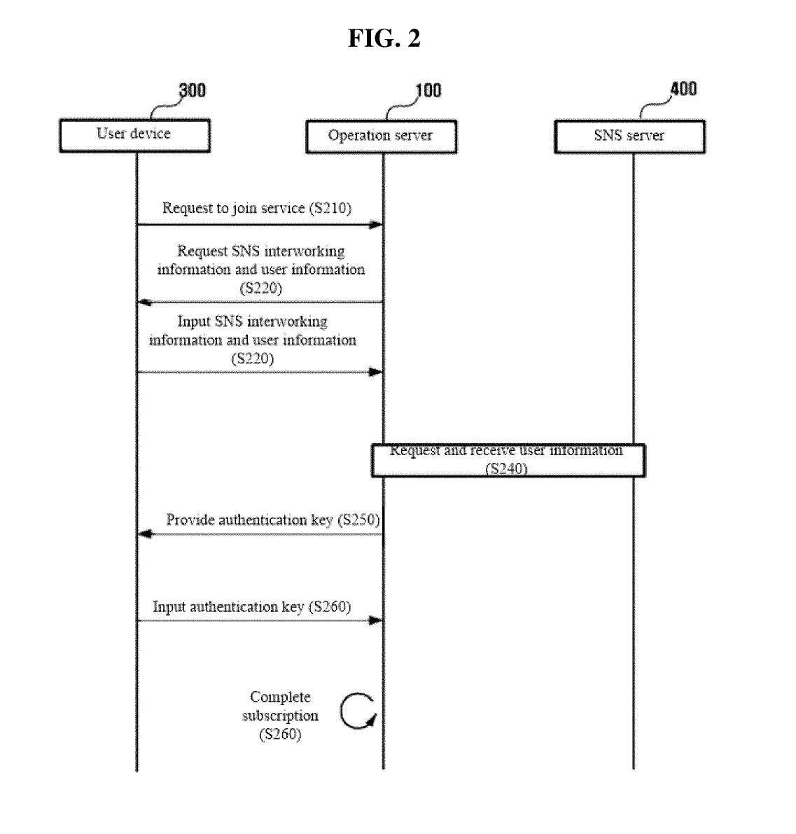

FIG. 2 is a signal sequence diagram illustrating a service subscription operation of a user at an operation server 100 according to various embodiments of the inventive concept. A description will be given of an example in which a user device 300 described with reference to FIG. 2 is one of a plurality of user devices which request to join a service to use the operation server 100.

According to various embodiments, in operation S210, the user device 300 may request the operation server 100 to join a service. For example, a user may request to register as a member by clicking on an item corresponding to a subscription box on a web site provided from the operation server 100 using the user device 300.

According to various embodiments, in operation S220, the operation server 100 may request the user device 300 to input user information. For example, the operation server 100 may output a subscription window to enter user information, such as an electronic mail (e-mail) address, a password, password verification, a nickname to be used, an age, and a gender, on the web site.

Further, the operation server 100 may request the user device 300 to input SNS interworking information. For this purpose, the operation server 100 may configure items associated with SNSs as user interface (UI) items of a form which may be distinguished from each other and may provide the UI items to the user device 300.

According to various embodiments, in operation S230, the user device 300 may input the SNS interworking information and the user information to the operation server 100. For example, the user may enter user information, such as an e-mail address, a password, password verification, a nickname to be used, an age, and a gender, in the subscription window via an input unit of the user device 300. Further, the user may provide the SNS interworking information to the operation server 100 by selecting at least one of items associated with SNSs through a screen provided from the operation server 100. Meanwhile, the operation server 100 may store the user information and the SNS interworking information input from the user device 100 in a memory (or a database). In this case, the user information and the SNS interworking information may be stored in the form of being matched to be correlated and found.

If the user provides the SNS interworking information to the operation server 100 via the user device 300, in operation S240, the operation server 100 may interwork with a related SNS server 400 on a temporary basis or on a periodic basis based on the SNS interworking information provided from the user device 300 and may receive information associated with the user from the SNS server 400. In this case, the information associated with the user may include at least one of profile information (e.g., a nickname, a profile photo, or the like) of the user, a list of writing, a public profile of the user, an e-mail address of the user, a timeline post, date of birth, photo information, or video information.

Meanwhile, before providing the information associated with the user to the operation server 100, the SNS server 400 may request the user device 300 to perform an authentication process for the SNS server 400 (e.g., log in to an SNS). For example, if an interworking request object is KakaoTalk™, a KakaoTalk™ server may request the user device 300 to enter an ID and a password.

If authentication of the user associated with the SNS server 400 is completed using the user device 300, the SNS server 400 may provide user related information to be provided to the operation server 100 and a screen which inquires of the user about whether he or she agrees with the user related information to the user device 300. If receiving the input that the user agrees with the user related information, the SNS server 400 may provide the user related information to the operation server 100. If receiving the input that the user does not agree with the user related information, the SNS server 400 may fail to provide the user related information to the operation server 100 and may stop interworking with the operation server 100.

According to various embodiments, in operation S250, the operation server 100 may transmit an authentication key (e.g., an authentication mail) to the e-mail address input through the user device 300. If the user verifies the authentication key using the user device 300 (e.g., if he or she clicks on an authentication verification button in the authentication mail), the verified information may be transmitted to the operation server 100. In operation S270, the operation server 100 may complete the subscription for the user.

The subscription procedure of the user according to various embodiments of the inventive concept should not be limited to the order. The operations of FIG. 2 may fail to include some of the operations or the order of the operations of FIG. 2 may be changed. For example, the operation of providing the authentication key to the user device 300 at the operation server 100 may be performed in response to an input of user information at the user device 300. Further, the SNS interworking information and the user information should not be requested simultaneously. The SNS interworking information may be requested to the user device 300 at a time after the user information is requested. Likewise, the SNS interworking information and the user information should not be input together. The SNS interworking information may be input at a time after the user information is input.

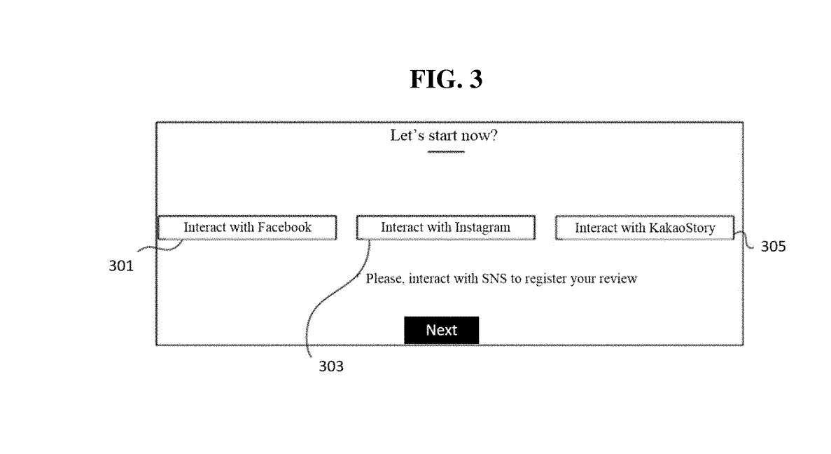

FIG. 3 is a drawing illustrating an operation where an operation server and an SNS server in which a user is registered interwork with each other according to various embodiments of the inventive concept. A screen of FIG. 3 may be output according to a request to additionally interwork with an SNS server 400 at a time or at a time after subscription during a subscription procedure of FIG. 2.

As shown, an operation server 100 may output a screen for requesting a user device 300 to input SNS interworking information. The request screen may include items 301 to 303 for selecting SNSs to interwork together with a guide message, “Let's start now?” The items 301 to 303 may include, for example, text of “interwork with Facebook™”, text of “interwork with Instagram™”, and text of “KakaoStory™”, respectively. Although not illustrated, if the request screen of FIG. 3 is output according to the request to additionally interwork with the SNS server 400 at the time after the subscription, the item corresponding to an SNS which interworks already among the items 301 to 303 may be output to be distinguished from items corresponding to SNSs which does not interwork yet.

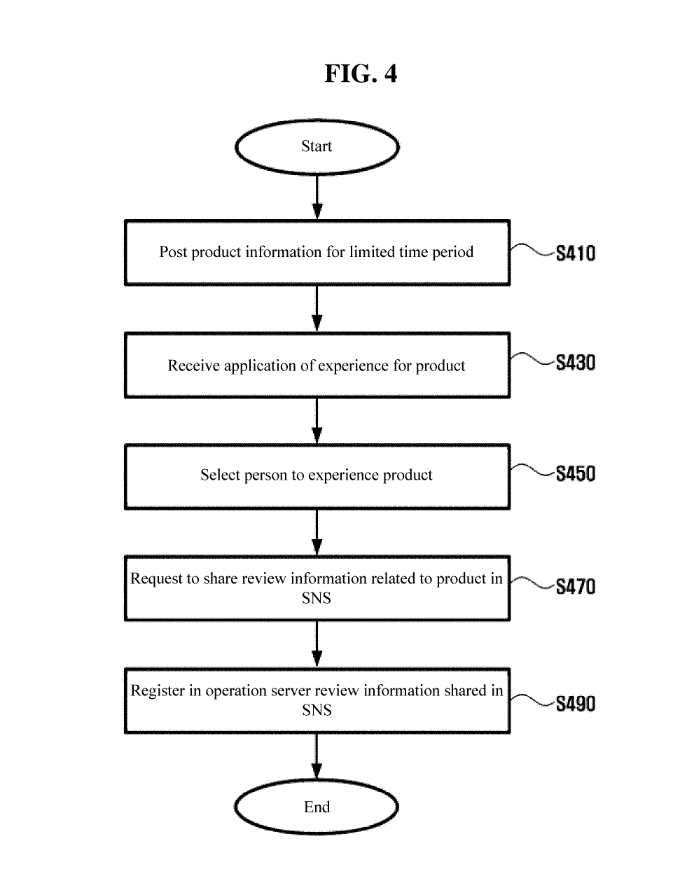

FIG. 4 is a flowchart illustrating a method for advertising a product according to various embodiments of the inventive concept.

According to various embodiments, in operation S410, an operation server 100 may post product information during a limited time period. For example, the operation server 100 may display a time (e.g., 72 hours) together with a product. The time may be displayed in the form of being counted in real time in an ascending or descending order.

According to various embodiments, in operation S430, the operation server 100 may receive an application for experiencing the product. For example, the operation server 100 may receive the application for experiencing the product from a user device 300 used by a user by providing product information displayed through an online webpage to click on the product information.

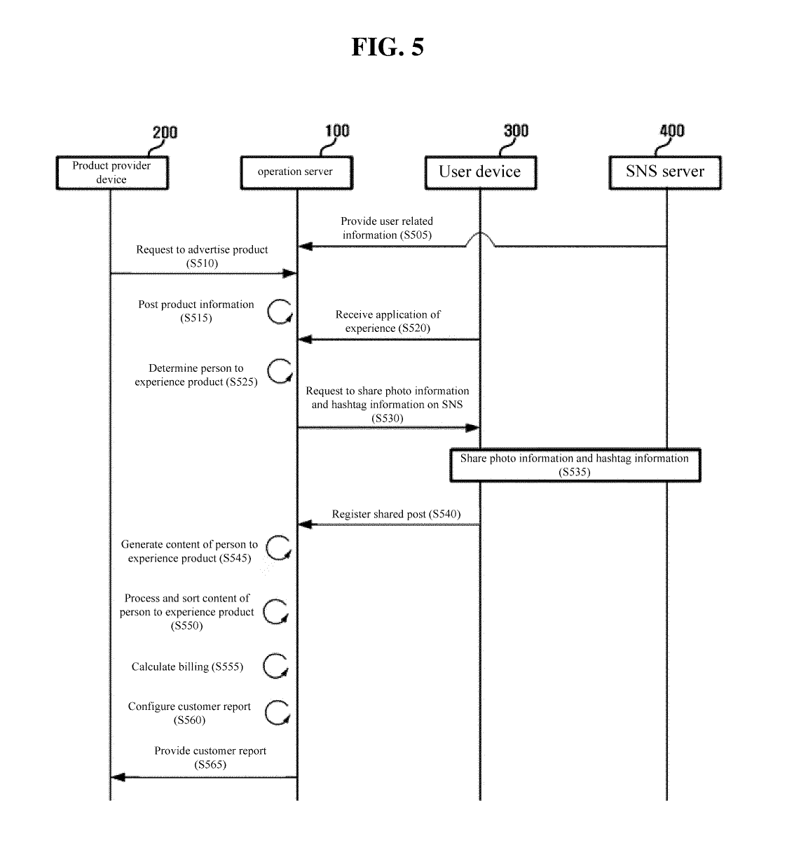

According to various embodiments, in operation S450, the operation server 100 may determine persons to experience the product. For example, if the limited time period elapses, the operation server 100 may select at least one person to experience the product according to an algorithm for selecting a person to experience the product among users who applies for experiencing the product. A description will be given in detail of various embodiments of such an algorithm with reference to FIG. 5. If persons to experience the product are selected according to the algorithm, the operation server 100 may provide the product to the selected persons to experience the product.

According to various embodiments, in operation S470, the operation server 100 may request the user device 300 of each of the persons to experience the product to register review information associated with the product as a new post in the SNS server 400 in which the person to experience the product is registered or share the registered new post with another user. In detail, the operation server 100 may request the user device 300 to share photo information including the product and hashtag information associated with the product on the SNS server 400. Further, the operation server 100 may request the user device 300 to share the photo information and the hashtag information during a time period or more.

A hashtag may be a function of expressing what is writing for a specific word in an SNS and may mean what is writing for a subject by adding a specific word to “#”. Such a hashtag may be a function of being introduced in an SNS for convenience of a search and may be used as a scheme or means of expressing interest and support for a specific subject as well as a search function.

Hashtag information used in various embodiments of the inventive concept may include at least one hashtag. The operation server 100 may request the person to experience the product to share at least one hashtag associated with the product on an SNS. According to various embodiments of the inventive concept, the hashtag information may include at least one of brand information of a product, product name information of the product, hashtag information associated with the operation server and tag information written by the person to experience the product in connection with the product.

As such, the inventive concept may optimize an advertisement propagation effect suitable for an SNS characteristic by using trendy Internet technology such as a hashtag in an SNS environment.

According to various embodiments, in operation S490, the operation server 100 may receive and register review information shared on the SNS server 400. For example, the operation server 100 may notify the user device 300 of the person to experience the product of information about the details to register a post including the photo information and the hashtag information shared on the SNS server 400 by the person to experience the product in the operation server 100 within a time period and may receive the review information (e.g., an SNS post) or a uniform resource locator (URL) address of the review information over a network (e.g., the Internet) from the user device 300 of the person to experience the product. Thereafter, the operation server 100 may store the received post in its storage unit.

According to various embodiments, if the person to experience the product does not share review information such as photo information and hashtag information during a time period or more, if he or she omits to share any one of the photo information and the hashtag information, if he or she omits to part of hashtag information, or if he or she does not write a minimum number of hashtags, the operation server 100 may transmit the details that he or she may receive a penalty to the user device 300. Such a penalty may be configured in the form of transmitting a warning or in the form of a blacklist. The blacklist may be stored in a memory or a database of the operation server 100. Further, the operation server 100 may reflect information (e.g., a blacklist) of persons to experience a product, who receives a penalty, in selecting persons to experience another product later.

In FIG. 4, after operation S470 of requesting to share the review information associated with the product on the SNS, the operation server 100 may start operation S490 of registering the shared review information in the operation server 100. However, various embodiments of the inventive concept are not limited thereto. As another embodiment, operation S470 may be performed after operation S490. In detail, the person to experience the product may first register information to be shared on an SNS and may then register the information registered in the operation server 100 in the SNS server 400. Further, the operation server 100 may provide a simple editing tool upon registration. In detail, the operation server 100 may provide the editing tool such that the user registers review information in the operation server 100 and simultaneously registers the review information in the SNS server 400.

FIG. 5 is a signal sequence diagram illustrating a detailed method for advertising a product according to various embodiments of the inventive concept. For convenience of description, in an operation of FIG. 5, it is assumed that at least one SNS server 400 and an operation server 100 interwork with each after a user joins a service of the operation server 100 in FIG. 2. Further, a user device 300 of FIG. 5 may refer to any one of a device of an applicant who requests to apply for a person to experience a product or a device of a user selected as the person to experience the product according to each operation of FIG. 5 and may refer to a single device or a plurality of devices.

According to various embodiments, in operation S505, an SNS server 400 may provide information associated with a user to an operation server 100. The information associated with the user may include at least one of profile information (e.g., a nickname, a profile photo, or the like) of the user, a list of writing, a public profile of the user, an e-mail address of the user, a timeline post, date of birth, photo information, or video information. Further, the operation of FIG. 5 for providing the information associated with the user to the operation server 100 at the SNS server 400 may continue being performed in real time or on a periodic basis.

According to various embodiments, in operation S510, a product provider device 200 may request the operation server 100 to advertise a product. For example, a product provider may transmit information associated with a product to be advertised and a request to promote the product to the operation server 100. For example, the operation server 100 may receive the information associated with the product, such as the number of products, a characteristic of each of the products, photo information of each of the products, a sales address (e.g., an internet site address) of a provider who sells the products, and description information of each of the products, and the request to promote the product, from the product provider device 200.

As not illustrated, to support a method for advertising a product based on a global platform, the operation server 100 may receive specified country information of a user to be selected as a person to experience a product from the product provider device 200. In this case, an operation of determining the person to experience the product, which will be described below, may be to determine the person to experience the product by verifying country information of a product applicant, primarily filtering applicants corresponding to the specified country information, and secondarily filtering applicants using an algorithm for selecting a person to experience a product. In this case, the operation server 100 may verify country information of an applicant based on at least one of an internet protocol (IP) address of the user device 300 which accesses a webpage, destination address information input in an operation of applying for experiencing the product, and address information input in an operation (FIGS. 2 and 3) of registering the SNS interworking information in the operation server 100.

According to various embodiments, in operation S515, the operation server 100 may process information associated with the product and may post the processed information on an online web site. In this case, the operation server 100 may post the information about the product online during a time. For example, the operation server 100 may configure a photo including the product together with a product name and the like in the form of an image and may post the image, thus inserting information about a limited time for applying for the product into the image.

According to various embodiments, in operation S520, the at least one user device 300 may request the operation server 100 to apply for experiencing the product. For example, a plurality of users who join a service of the operation server 100 may view a product posted on a webpage of the operation server 100 and may transmit a request to be selected as a person to experience the product (e.g., a social editor) to the operation server 100 via the user device 300. The operation server 100 may receive a request to experience the product from at least one or more users who register SNS interworking information.

According to various embodiments, in operation S525, the operation server 100 may determine at least one person to experience the product among the users who apply for experiencing the product.

In detail, if a limited time elapses, the operation server 100 may select the at least one person to experience the product according to a condition (e.g., the algorithm for selecting the person to experience the product) among the users who apply for experiencing the product. Such an algorithm may include an algorithm for collecting information in which SNS users act on an SNS and verifying whether the collected information meets a constant condition.

In more detail, to operate the algorithm, first of all, the operation server 100 may collect SNS activity information of applicants from the SNS server 400. Herein, the SNS activity information of the applicants may include at least one of information associated with a post of an applicant, posted on the SNS server 400, and feedback information collected from other SNS users on the post. The SNS activity information of the applicants may be collected during a time period from a time when the operation server 100 receives a request to experience the product via the user device 300. To this end, if an application for experiencing the product is received from an applicant, the operation server 100 may verify the at least one SNS server 400, in which the applicant is registered, based on user information of the applicant or the like and may request to the verified SNS server 400 to interwork.

As an example of the algorithm, the operation server 100 may verify whether SNS activity information of an applicant meets minimum selection criteria during a time period.

For example, the operation server 100 may select persons to experience the product based on the minimum selection criteria of determining whether an SNS user obtains (predetermined) feedback information (e.g., “like”, “comment”, or the like) on the SNS a number of times or more for a time period such as one week or one month. Herein, the feedback information may be information which may be added to a post, registered by the user, by another user and may be information (e.g., “like”, “comment”, “share”, or the like) which is classified in various manners according to a service policy on the SNS server 400.

Herein, the term “like” may be one of a plurality of feedback information, in which another SNS user positively rates a post created by an SNS user on an SNS. The term “comment” may be information in which another user enters a comment on the post created by the SNS user. The feedback information may be determined in various manners according to a policy of the operation server 100, a support policy of the SNS server 400, or user settings.

If the SNS activity information of the applicants meets the minimum selection criteria, the operation server 100 may group the applicants based on the SNS activity information of the applicants and may determine a rate at which a person to experience a product is selected for each group. Herein, the rate at which the person to experience the product is selected may refer to a rate of the number of users which may be selected as persons to experience the product in each group.

In detail, the operation server 100 may group the applicants with respect to SNS activity information of the applicants, received from the SNS server 400, and specific information (e.g., information about the number of followers) included in the SNS activity information. Simultaneously or sequentially, the operation server 100 may determine a rate, at which a person to experience a product is selected, corresponding to a plurality of groups. Herein, the grouped information and information about the rate at which the person to experience the product is selected may be stored or updated in a memory or database of the operation server 100.

In addition, the operation server 100 may randomly extract a person to experience a product from each group under a condition where a rate at which a person to experience a product is selected, the rate being set for each group.

The grouping process may be to provide a higher opportunity to be selected as a person to experience a product to an applicant who actively performs SNS activity and provide an opportunity to be selected as the person to experience the product to an applicant who passively performs SNS activity, by a process of setting a rate at which the person to experience the product is selected according to each group and the algorithm of randomly determining the person to experience the product under a condition.

Further, as described above, the operation server 100 may primarily verify whether specified country information received via the product provider device 200 corresponds to country information of applicants and may finally determine a person to experience a product among the corresponding applicants by the algorithm.

The operation of determining the person to experience the product in operation S525 may be performed during the time or if the time is ended.

According to various embodiments, the operation server 100 may receive different information from the SNS server 400 by distinguishing a time period when the user selected as the person to experience the product promotes the product on the SNS from when the user is registered (e.g., registers as a member) in the operation server 100.

For example, if interworking with the SNS server 400 in the member registration process of the user, the operation server 100 may receive basic or summary information, such as a nickname and a profile photo, from the SNS server 400 which interworks with the operation server 100.

Contrary to this, if the user is determined as the person to experience the product and shares review information during a time on the SNS server 400, the operation server 100 may receive SNS activity information of the person to experience the product (e.g., information about feedback on the review information) from the SNS server 400. The SNS activity information of the person to experience the product may be detailed information of the user, which may be collected in the SNS server 400, rather than the nickname and the profile photo. In this case, the operation server 100 may verify feedback information (e.g., the obtained number of “comments” and the obtained number of “likes”) in the SNS activity information of the person to experience the product, received from the SNS server 400.

In this case, in operation S525, the algorithm for determining the person to experience the product may be calculated based on the SNS activity information of the person to experience the product.

According to various embodiments, in operation S530, the operation server 100 may provide the product to the person to experience the product and may request the user device 300 of the person to experience the product to share review information associated with the product (e.g., photo information and hashtag information) during a time period or more on the SNS server 400. If the at least one person to experience the product is selected according to the algorithm, such a request may be performed manually or automatically by an e-mail, a text message such as an SMS message, a voice call, or the operation server 100.

Further, the operation server 100 may request the user device 300 to share link information of a product provider site during a time period or more on the SNS server 400. The link information of the product provider site may be, for example, a UI item having a URL address of an Internet sales site at which a product provider sells a product or link information configured to automatically move to the Internet sales site upon being clicked. In addition, the operation server 100 may request the user device 300 to share postscript information of the person to experience the product for the product on the SNS server 400. The postscript information may be, for example, text information mentioned for the product by the person to experience the product.

According to various embodiments, in operation S535, the person to experience the product may share review information associated with the product (e.g., photo information including the product and hashtag information associated with the product) with other users on the SNS server 400 via the user device 300 and the SNS server 400. In other words, the person to experience the product may upload at least one of the photo information including the product, the hashtag information associated with the product, link information of a product provider site for the product, and postscript information for the product or data in which they are combined to the SNS server 400.

According to various embodiments, in operation S540, the person to experience the product may register the review information (e.g., a post) shared on the SNS server 400 in the operation server 100. Further, the user may input URL address of the review information rather than the review information or together with the review information.

In detail, the operation server 100 may guide the user device 300 to register review information such as a post including the photo information and the hashtag information shared on the SNS server 400 by the person to experience the product or a URL address of the review information within a time period in the operation server 100. Further, the operation server 100 may receive the review information or the URL address of the review information over the network (e.g., the Internet) from the user device 300.

In FIG. 5, the person to experience the product may first register the review information in the SNS server 400 and may then register the registered review information in the operation server 100. However, this order may be changed. In other words, the person to experience the product may first register information to be shared on the SNS server 400 in the operation server 100 and may then register the information registered in the operation server 100 in the SNS server 400. Further, the operation server 100 may provide a simple editing tool upon registration. In detail, the operation server 100 may provide the editing tool to register review information in the SNS server 400 as soon as the user registers the review information in the operation server 100. According to various embodiments, in operation S545, the operation server 100 may generate content (e.g., a widget) of the person to experience the product, based on at least one of review information registered from the user device 300, user information of the person to experience the product, stored in the operation server 100, and SNS activity information (e.g., feedback information) of the person to experience the product, received from the SNS server 400. Such content may include at least one of photo information including the product, hashtag information associated with the product, and the SNS activity information of the person to experience the product, such as the feedback information and may be configured by a combination of at least one of text, an image, and a video.

The content of the person to experience the product may be of a form processed to be the same or different from review information uploaded to the operation server 100 via the user device 300 by the person to experience the product. The operation server 100 may generate content of each of a plurality of the persons to experience the same product by registering a post from the user device 300 of each of the plurality of persons to experience the same product and processing the registered post.

According to various embodiments, in operation S550, the operation server 100 may sort, reprocess, or arrange content of the persons to experience the product based on the feedback information received from the SNS server 400. For example, the operation server 100 may determine a display order of the content of the persons to experience the product on a web or may reprocess the content in a different form (e.g., resize the content), based on feedback information (e.g., the obtaining number of “likes” or “comments”) in SNS activity information of the persons to experience the product, received on a real time basis or on a periodic basis from the SNS server 400.

In this case, in the display order, content of a person to experience a product (the best person to experience the product, which will be described below), who receives the most feedback information, may be displayed on an uppermost or leftmost side of a webpage. In the display order, content of a person to experience the product, which receives the second most feedback information, may be output to be subsequent to the content of the person to experience the product, who receives the most feedback information, in at least one direction or may be output to be distinguished on another region. Further, the operation server 100 may update a display order or a display form of content of the persons to experience the product, during a time period when the product is advertised in the SNS server 400.

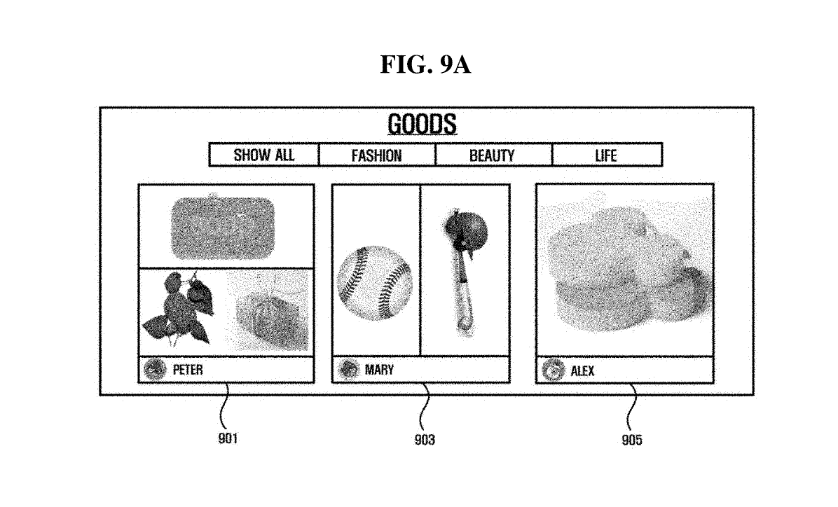

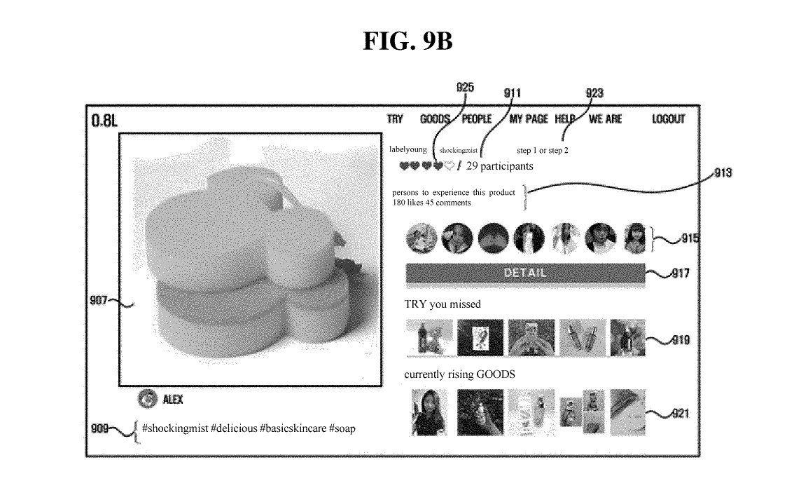

Further, the operation server 100 may select the person to experience the product, who receives the most feedback information, among persons to experience the product as the best person to experience the product. For example, the operation server 100 may verify the obtaining number of “likes” and “comments” among feedback information received on a real time basis or on a periodic basis from the SNS server 400 and may configure a screen on a web to distinguish content of the best person to experience the product from content of another person to experience the product. For example, the operation server 100 may distinctively output the content of the best person to experience the product at an upper side or any one side of content of another person to experience the product on a web by enlarging the content of the best person to experience the product or inserting additional information into the content of the best person to experience the product. A description will be given of a detailed operation associated with configuring such a screen with reference to FIGS. 9A and 9B. Further, the selecting of the best person to experience the product may be performed at any time during a time period when the product is advertised on the SNS server 400 or after the time period is ended.

According to various embodiments, the operation server 100 may provide a reward to the best person to experience the product, selected after the time period is ended. Persons to experience the product may more aggressively advertise the product on an SNS by the selection of the best person to experience the product and the providing of the reward according to the selection. A product provider or a general consumer may intuitively determine a degree of advertising activities of the persons to experience the product.

According to various embodiments, in operation S555, the operation server 100 may count an operation requested through a billing item included in the content of the person to experience the product to calculate billing. For this purpose, when generating the content of the person to experience the product or after generating the content of the person to experience the product, the operation server 100 may generate or process the content of the person to experience the product by further including at least one billing item associated with the product advertised by the person to experience the product. The billing item may include an SNS link item having link information which interworks such that the person to experience the product verifies a post which is being shared on the SNS server 400. Further, the billing item may include a sales site link item including link information of a product provider site. Such a sales site link item may be implemented to have information about a link moved to an Internet sales site upon being clicked.

According to various embodiments, the operation server 100 may count various operations requested through the link item included in the person to experience the product to calculate billing. For example, the operation server 100 may count at least one of an operation of clicking on the sales site link item or the SNS link item, an operation of completing a subscription to a sales site linked through the sales site link item, an operation of purchasing the product on the sales site linked through the sales site link item, and an operation of verifying a post (e.g., photo information and hashtag information) shared by the person to experience the product through the SNS link item. The method for calculating billing according to such count operations may be performed in various forms by a cost-per-click (CPC) scheme, a cost-per-sales (CPS) scheme, a cost-per-action (CPA) scheme, or the like.

According to various embodiments, in operation S560, the operation server 100 may generate a customer report for the product. For example, the operation server 100 may configure or generate a result repot based on at least one of information received from the SNS server 400 after a time period (e.g., a time period requested to share a post for the product on the SNS server 400 from the operation server 100 to the user device 300) is ended in connection with the product and information stored in the operation server 100 with respect to the product.

According to various embodiments, the result report may include at least one of a product name of the product, a category, the number of recruited persons to experience the product, a time period when persons to experience the product are recruited, a review time period of the person to experience the product (e.g., a time period when the product is shared on an SNS), hashtag information, link information (e.g., a sales site link item and an SNS link item), information about a post shared on the SNS server 400, user information of the person to experience the product, a type of the SNS server 400, the number of users who apply for each SNS server, the number of persons to experience the product, selected for each SNS server, the number of followers of the person to experience the product, status information about a recent post of the person to experience the product, and content of the person to experience the product. Further, the operation server 100 may configure the information included in the result report in a quantitative manner For example, the information included in the result report may be configured through a table, a graph, or the like.

According to various embodiments, in operation S565, the operation server 100 may provide the generated customer report to the product provider device 200.

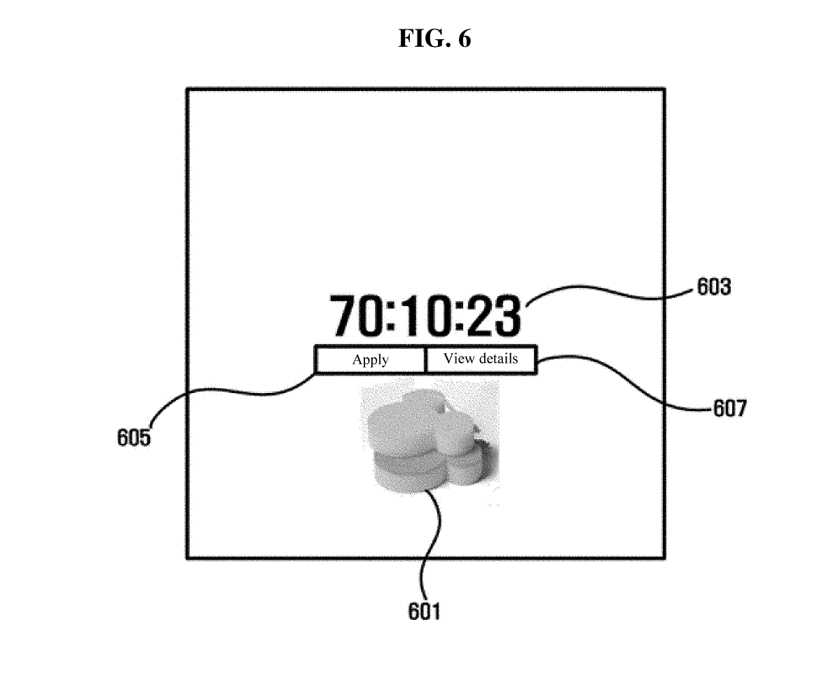

FIG. 6 is a drawing illustrating an operation in which an operation server 100 displays a screen where a product application is received during a time through a webpage in a method for advertising a product according to various embodiments of the inventive concept.

As shown, the operation server 100 may output image information 601 associated with a product to be requested for promotion by a product provider, an application item 605 requested to be selected as a person to experience the product (e.g., a social editor), a product provider site link item 607, and information 603 about a time period of an application for the person to experience the product. If a user clicks on the application item 605, the operation server 100 may output a screen for inputting information about a destination to receive the product. If the user clicks on the product provider site link item 607, the operation server 100 may output a product provider site.

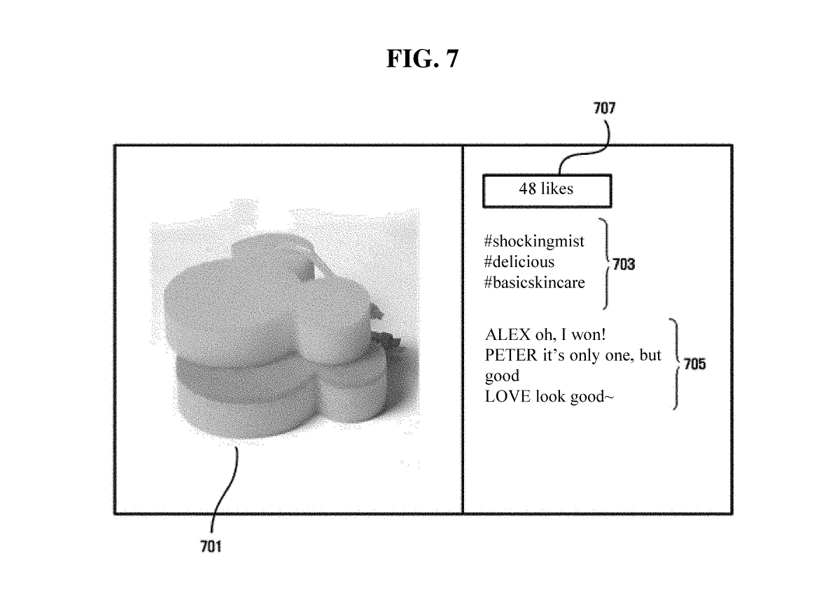

FIG. 7 is a drawing illustrating review information about a product posted on an SNS server 400 in a method for advertising the product according to various embodiments of the inventive concept.

As shown, a person to experience a product may publish a post including photo information 701 including the product and hashtag information 703 associated with the product on the SNS server 400. “Comment” information 705 and “like” information 707 as feedback information obtained from another user who uses the SNS server 400 may be displayed on the post.

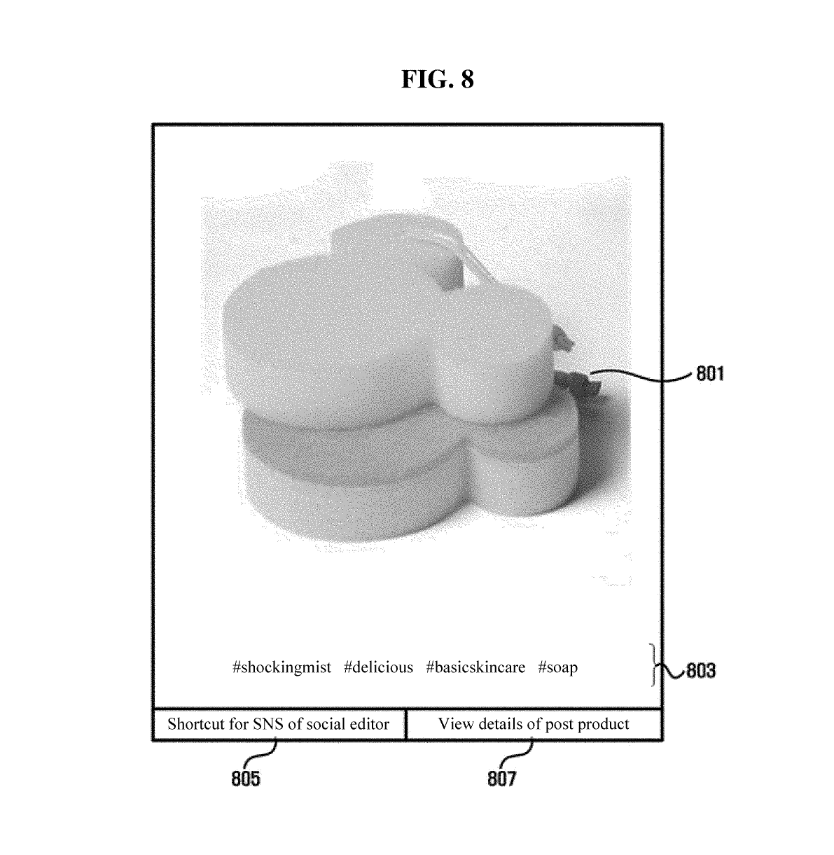

FIG. 8 is a drawing illustrating a review information screen of a product registered in an operation server in a method for advertising the product according to various embodiments of the inventive concept.

An operation server 100 may register review information (e.g., photo information and hashtag information) shared on an SNS server 400 from a person to experience a product. As shown, the operation server 100 may generate content of the person to experience the product to include at least part of the registered review information. The content of such a person to experience the product may include photo information of the product and hashtag information 803 associated with the product. Further, the content of the person to experience the product may include an SNS link item 805 and a sales site link item 807. The SNS link item 805 and the sales site link item 807 may be used as billing items. For example, the operation server 100 may calculate billing by counting at least one of an operation of inputting (e.g., clicking on) the billing item, an operation of registering as a member and purchasing the product in a sales site which interworks by clicking on the billing item, or an operation of verifying a post on the SNS server 400 connected through the billing item. The operation server 100 may request to provide the calculated billing to a product provider.

FIG. 9A is a drawing illustrating content of the best person to experience a product for each product in a method for advertising the product according to various embodiments of the inventive concept. FIG. 9B is a drawing illustrating an operation of providing a screen associated with content of the best person to experience the product in a method for advertising a product according to various embodiments of the inventive concept.

As shown, content 901 of a person to experience a product (e.g., the best person to experience the product), who obtains the most feedback information on an SNS server 400 among persons to experience a first product may be displayed. Similarly, content 903 of the best person to experience a second product and content 905 of the best person to experience a third product may be displayed. If a specific user clicks on the content 905 of the best person to experience the third product, an operation server 100 may output a screen of FIG. 9B.

Further, although not illustrated, the operation 100 may post the persons to experience the products for each product as shown in FIG. 9A. However, the operation server 100 may determine the best person to experience a product in an order where a person to experience all products obtains the most feedback information among persons to experience all the products irrespective of the product.

As shown in FIG. 9B, the operation server 100 may post photo information 907 including the product, hashtag information 909 associated with the product, product name information 923, information 911 about the number of persons to experience the product, feedback information 913 obtained on the SNS server 400 on the product, content link information 915 of persons to experience the product, information about a comment in which persons to experience the product rate the product, a sales site link item 917, information 919 about another product, and content information 921 of persons to experience another product. The information 925, about the comment in which the persons to experience the product rate the product, among the elements may be information about the product registered in the operation server 100 via the user device 300 by the persons to experience the product.

Further, although not illustrated, content of other persons to experience the product or a thumbnail image of the content may be output on a specific region of a screen of FIG. 9B (e.g., a screen output if being scrolled downward) by a condition. The condition may be, for example, an order where feedback information is obtained. If the thumbnail image of the content is clicked, the operation server 100 may output a plurality of content of the persons to experience the product on a new window or may overlap and output the plurality of content of the persons to experience the product. A product provider or consumers who refer to a webpage of the operation server 100 may intuitively determine whether persons to experience the product except for the best person to experience the product promote the product in any manner on the SNS server 400.

As such, an advertisement for the product may be naturally propagated online by advertising the product using an SNS activity of the person to experience the product, particularly, photo information and the hashtag information according to various embodiments of the inventive concept. A more effective advertisement may be performed using technology suitable for an SNS characteristic.

Further, a product provider or a general consumer may intuitively determine a degree of advertising activities of persons to experience the product by sorting a plurality of content of the persons to experience the product based on a specific condition.

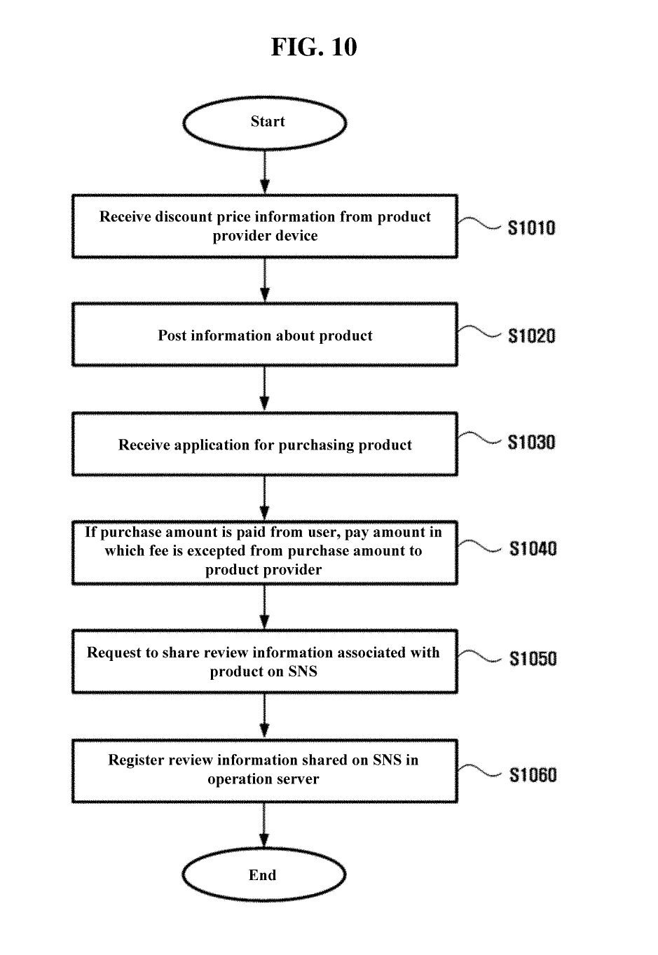

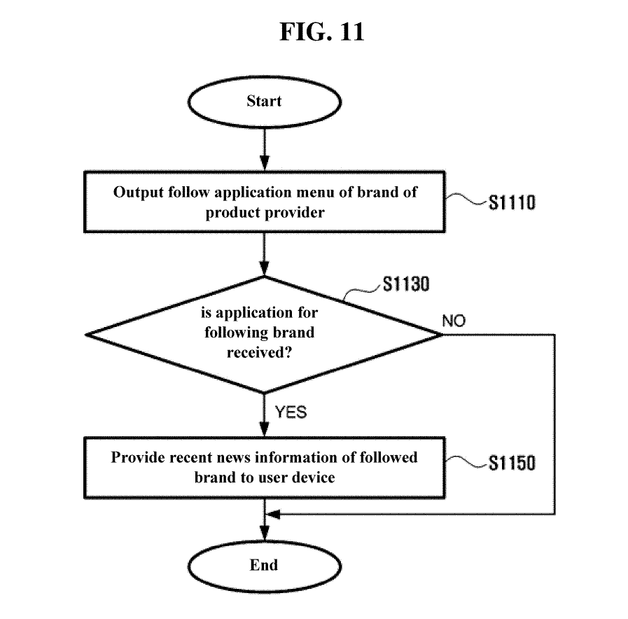

Hereinafter, a description will be given of a method for selling a product according to various embodiments with reference to FIGS. 10 and 11. The method for selling the product, described with reference to FIGS. 10 and 11, may be common in that it is performed based on SNS activity information of a user as compared with the above-mentioned method for advertising the product. Herein, the method for advertising the product may be to provide a limited amount of the products to the user determined as the person to experience the product and request to share review information about the product on an SNS. The method for selling the product, which will be described below, may have a difference in that it provides an unlimited amount of products to the user at a discounted price and requests to expose review information about the product on an SNS.

FIG. 10 is a flowchart illustrating a method for selling a product according to various embodiments of the inventive concept. Details repeated with details of FIG. 4 among details described with reference to FIG. 10 will be omitted.

According to various embodiments, in operation S1010, an operation server 100 may receive discount price information from a product provider device 200. In detail, the operation server 100 may receive the discount price information generated by subtracting an SNS advertising price information value calculated as an SNS advertising cost from consumer price information about a product from the product provider device 200.

Herein, the consumer price information may refer to price information of a product sold offline or online by a product provider. According to various embodiments, such consumer price information may be the lowest price information provided from an open market.

According to various embodiments, since an advertising effect on a product is provided using an SNS activity of a user, the operation server 100 may provide the product to the user in an amount which is more discounted than the consumer price information corresponding to the lowest price. Thus, a manager of the operation server 100 may discuss with a product provider to provide the product to the user in the discount price information generated by subtracting the SNS advertising price information from the consumer price corresponding to the lowest price and may receive discount price information derived from the discussion via the product provider device 200.

According to various embodiments, in operation S1020, the operation server 100 may post information about the product on an online webpage. In this case, the information about the product may include the discount price information.

According to various embodiments, in operation S1030, the operation server 100 may receive an application for purchasing the product through the user device 300 and the webpage. In detail, the operation server 100 may receive the application for purchasing the product via a user device 300 of each of at least one or more users from the at least one or more users who register SNS interworking information for interworking with at least one SNS in the operation server 100.

According to various embodiments, in operation S1040, if a purchase amount corresponding to the discount price information is paid from the user, the operation server 100 may pay an amount in which a fee for each product is excepted from the purchase amount to the product provider. For example, if the user requests payment (e.g., instant purchase) in an amount corresponding to the discount price information, the operation server 100 may call or link a payment related system and may support such that the user completes payment via the user device 300. If payment completion or receipt of a purchase amount is verified, the operation server 100 may pay an amount except for a fee for each product to an account of a name of a product provider or the product provider device 200.

According to various embodiments, in operation S1050, the operation server 100 may request to share review information associated with the product on an SNS. In detail, the operation server 100 may provide a product to a user who pays a sale amount and may request the user device 300 of the user to share the review information associated with the user with another user on the SNS server 400 in which the user is registered.

Further, although not illustrated, similar to a method for advertising a product, the above-mentioned operations of the drawings may be performed in the method for selling the product.

For example, the operation server 100 may register review information to be shared on the SNS server 400. In this case, according to various embodiments, the operation server 100 may provide an editing tool for supporting to register the review information in the SNS server 400 concurrently or sequentially with registering the review information to be registered on the SNS server 400 in the operation server 100. If the user registers review information in the operation server 100 using the editing tool, the operation server 100 may register the review information in both of the operation server 100 and the SNS server 400.

Further, as described above in the method for advertising the product, in the method for selling the product, the operation server 100 may receive SNS activity information of the user, collected from the SNS server 400 with respect to review information during a time period, from the SNS server 400. The operation server 100 may configure content or widgets of the users based on at least one of the review information, the SNS activity information of the user, and user information registered in the operation server 100. Thereafter, the operation server 100 may post the configured content or widgets of the users online.

Further, as described above in the method for advertising the product, in the method for selling the product, the operation server 100 may output a follower application menu for interesting and registering a brand associated with the product online. If a request to follow the brand is received from the user through the follower application menu, the operation server 100 may provide recent news information of the followed brand to the user device 300.

Various embodiments of the method for selling the product in FIG. 10 or the above-mentioned method for advertising the product may be shared. For example, if the user does not share review information associated with the product with another user on the SNS server 400, the operation server 100 may transmit a warning message to the user device 300 or may add a penalty by managing the user on a blacklist.

As such, in various embodiments, a method for directly selling a product in an amount discounted on a condition that SNS activity is requested to a purchase user as well as selecting a person to experience the product may be provided. Thus, a product provider and a consumer may be directly connected, and the user may create an environment in which he or she may use the product at the cheapest price concurrently with efficiently supporting a product advertising effect of the product provider.

FIG. 11 is a flowchart illustrating an operation where a user interests and registers a brand of a specific product provider in a method for advertising or selling a product according to various embodiments of the inventive concept. Hereinafter, an embodiment is exemplified as the interesting and registering is a “follow”. Herein, the interesting and registering or the follow may be a function an operation server 100 supports itself. In other words, the interesting and registering or the follow may be a function or service provided by the operation server 100 such that the user receives news of a product of a specific product provider.

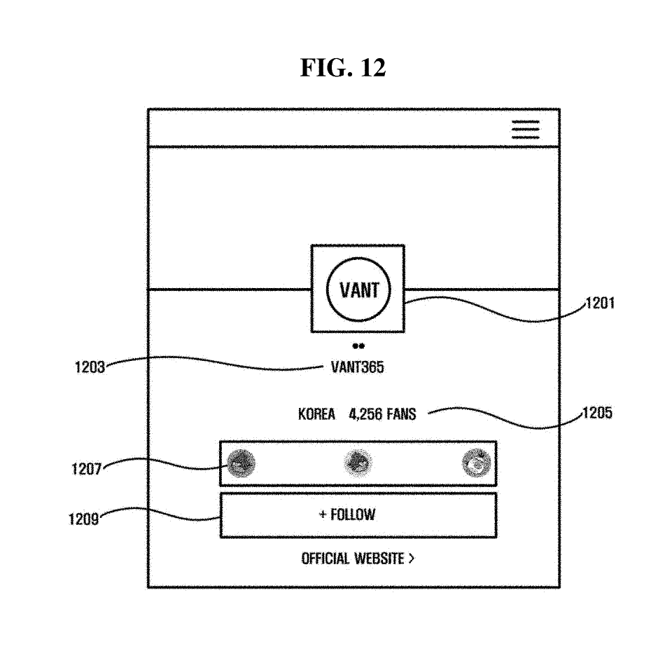

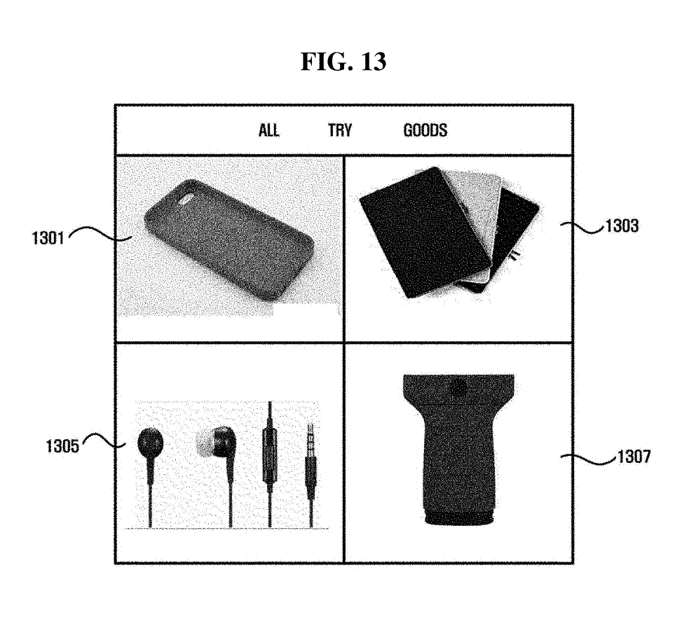

Meanwhile, exemplary drawings associated with an operation of FIG. 11 are disclosed with reference to FIGS. 12 and 13. FIG. 12 is a drawing illustrating a menu screen where a user interests and registers a brand of a specific product provider. FIG. 13 is a drawing illustrating a screen of sorting product information relative to a brand of a specific product provider.

According to various embodiments, in operation S1110, the operation server 100 may output a follow application menu of a brand of a product provider. In detail, the operation server 100 may provide information about a brand for allowing the user to identifying a specific product provider, a product associated with the brand information, and a menu for following the brand information on a webpage. The user may follow the brand information through the menu.

For example, as shown in FIG. 12, the operation server 100 may output a logo image 1201 of a specific product provider (or a company) and information 1203 about a company name “VANT 365”. Herein, at least one of the logo image 1201 and the company name information 1203 may refer to brand information of a product provider. In detail, number information and country information of followers who currently follow the “VAN375” may be displayed on a separate region 1205. Photo information 1207 of the followers who currently follow the company may be displayed.

Further, as shown in FIG. 13, the operation server 100 may display product information 1301 to 1307 provided from the brand “VANT365” on a webpage relative to the brand “VAN365”.

According to various embodiments, in operation S1130, the operation server 100 may determine whether an application for following a brand is received from a user device 300. For example, the operation server 100 may determine whether a follow application is received through a follow application menu 1209 of FIG. 12 from the user device 300. An embodiment is exemplified as such a follow application menu 1209 is output on a specific region on a screen of FIG. 12. However, various embodiments of the inventive concept are not limited thereto. For example, the follow application menu may be output on another region of a webpage. The operation server 100 may receive a follower application from the user through the follow application menu output on the other region.

If the application for following the brand is received from the user device 300, in operation S1150, the operation server 100 may provide recent news information of the followed brand to the user device 300. To this end, the operation server 100 may match brand information followed by the user to user information of the user to store the matched information. Thereafter, if a product of a product provider corresponding to the brand is requested to be advertised or sold through a product provider device 200, the operation server 100 may provide recent news information associated with the product of the brand to the user device 300 of a user who follows the brand.

Meanwhile, if the application for following the brand is not received from the user device 300, the operation of the FIG. 11 may be ended.

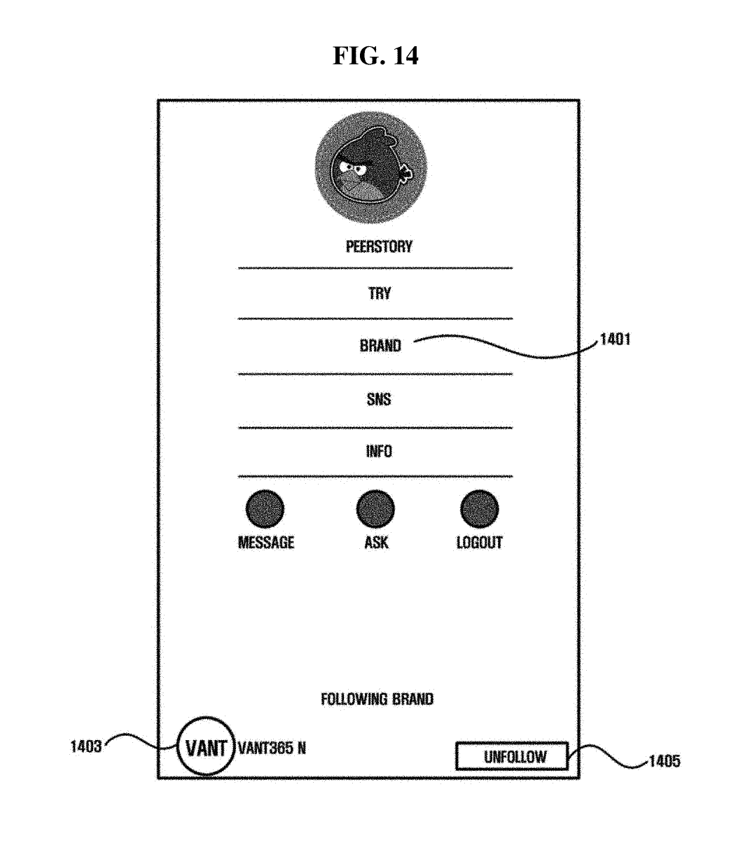

If a specific brand is followed through the operations and examples of FIGS. 11 to 13, the user may verify a screen of FIG. 14 on a user information screen of a webpage. As shown, as a brand information region 1401 of the user information screen is activated, brand information 1403 followed by the user may be displayed. Meanwhile, the operation server 100 may output an unfollow selection region 1405 on the user information screen. If a user selection input on the unfollow selection region 1405 is received, the operation server 100 may set the followed brand not to be followed any longer.

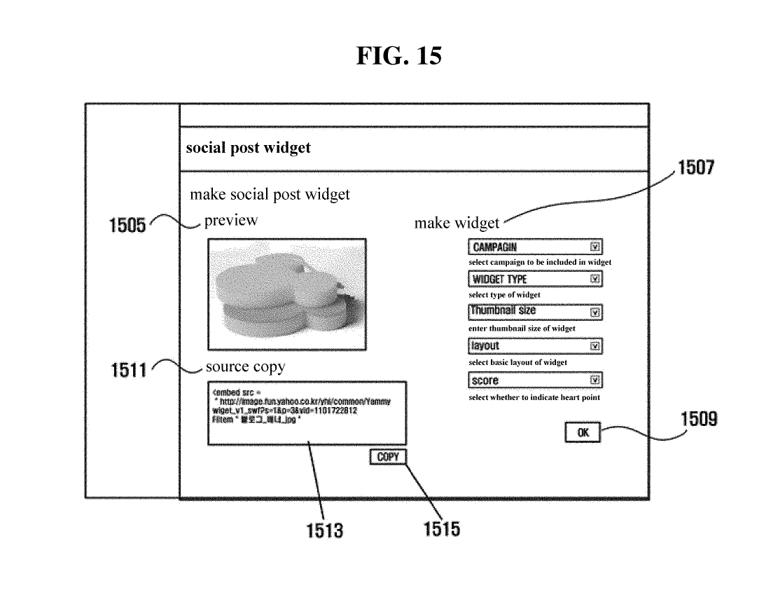

FIG. 15 is a drawing illustrating a widget generation editing tool provided from an operation server to a product provider according to various embodiments of the inventive concept.

In detail, an operation server 100 may provide a widget generation editing tool for generating a widget based on information registered in the operation server 100 by a person to experience a product or a purchaser (user) to a product provider.

For example, the product provider may enter a partner center through a product provider device 200 and a webpage of the operation server 100 and may enter a social post widget menu shown in FIG. 15 among menus of the entered partner center. The product provider may select a campaign (content of the person to experience the product or the user) and may input a layout and size of a widget to be made through a widget making region 1507. Thereafter, if the product provider clicks on an OK item 1509, a preview screen and source information of a widget to be made through a preview region 1505 and a source copy region 1511 may be generated. The product provider may copy source information generated by clicking on a copy region 1515 and may use the copied source information in a sales site or the like of the product provider.

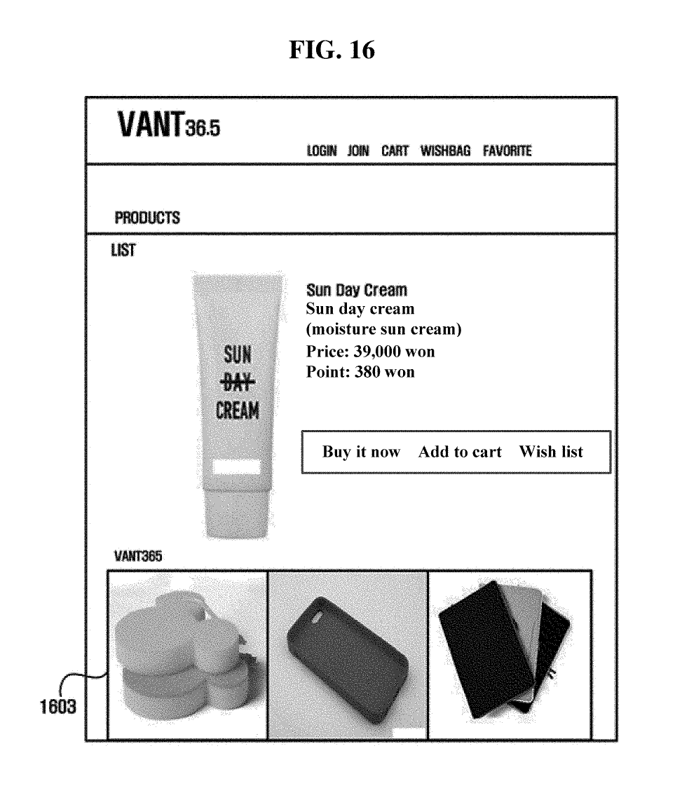

FIG. 16 is a drawing illustrating an operation where a product provider uses a widget generated in FIG. 15 in a web site of a product provider. As shown, a widget generated in FIG. 15 may be displayed on a widget display region 1603 in a sales site of a product provider. Such a widget display region 1603 may be freely applied according to a site operation direction. For example, photos may be displayed on the widget display region 1603 in an order where much feedback information (e.g., “like”) is received. Further, when such a widget display region 1603 is clicked, a link operation moved to a webpage screen (e.g., FIG. 9B) of an operation server 100, which displays content of a person to experience a product and a user, corresponding to the clicked region, may be performed.

The function of generating the widget in FIGS. 15 and 16 may help to determine purchase intent of a consumer of the product provider. The recognition that the product is a popular product on an SNS may be established through the function. The function may guide a consumer to search for a hashtag on the SNS. Further, there is no the necessity of forcing a consumer to register a product review as review content with high reliability is exposed as a 100% real post.

At least some of the elements and the operations according to various embodiments described herein may be implemented with a command, a routine, or instructions, stored in a computer-readable storage medium in the form of a program module. Such a storage medium may be stored in a storage unit and may include a computer-readable storage medium. Such a storage medium may include all types of storage media which store a program and data readably by a computer system. For example, the storage medium may include a read only memory (ROM), a random access memory (RAM), a compact disk (CD), a digital video disk-ROM (DVD-ROM), a magnetic tape, a floppy disc, an optical data storage device, a flash memory device, or the like. Further, such a storage medium may be distributed to a computer system connected over a network and may store a computer-readable code on a distributed basis to be executed.

According to various embodiments of the inventive concept, an advertisement for a product may naturally be propagated online by advertising the product using an SNS activity of a person to experience the product.

Further, an advertising propagation effect suitable for an SNS characteristic may be optimized by using trendy Internet technology for requesting the person to experience the product to share a photo and hashtag associated with the product on an SNS.

Further, a product provider or a general consumer may intuitively determine a degree of advertising activities of persons to experience the product by receiving SNS activities of the persons to experience the product from an SNS server and sorting information of the persons to experience the product on a webpage.

In addition, the persons to experience the product may be inspired to more aggressively advertise the product on the SNS by determining the best person to experience the product among the persons to experience the product and providing a reward to the best person to experience the product.

Further, an effective advertising effect on the product, which is not excessive and is natural, may be obtained by requesting the person to experience the product to simply promote review information associated with the product and using a human network (e.g., a follower or the like) of the person to experience the product.

Further, accessibility of an application for the product may reinforced by properly adjusting criteria for determining the person to experience the product and providing an opportunity to determine general users, who are not active on the SNS, as persons to experience the product.

Further, an operation server may generate native content and may increase trust of a potential purchaser for a product purchaser through content using the product to enhance a purchase rate.

In addition, a platform of efficiently selling or advertising the product without a complicated middle process may be provided by connecting a product provider with a consumer.

Lastly, according to a method for selling a product according to various embodiments of the inventive concept, an advertising effect for naturally propagating the product of the product provider through the SNS may be provided to the product provider. A product with an amount which is more discounted than the lowest price may be provided to a consumer.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for advertising a product based on a social network service (SNS) activity of a user, the method comprising:
posting, by an operation server, information about the product online during a time;
receiving, by the operation server, an application for experiencing the product via a user device of each of at least one or more users from the at least one or more users who register SNS interworking information for interworking with at least one SNS server in the operation server;
if a time elapses, determining, by the operation server, at least one or more persons to experience the product to promote the product among users who applies for experiencing the product according to a condition;
providing, by the operation server, the product to the persons to experience the product and requesting, by the operation server, the user device to share review information associated with the product with another user on an SNS server in which the persons to experience the product are registered, the review information including hashtag information associated with the product and photo information including the product;
receiving, by the operation server, SNS activity information collected from the SNS server during a time period with respect to the review information from the SNS server;
configuring, by the operation server, content of the persons to experience the product, based on at least one of the review information, SNS activity information of the persons to experience the product, and user information of the persons to experience the product, the user information being registered in the operation server;
outputting, by the operation server, a widget generation editing tool for generating a widget through a product provider device based on the configured content;
generating and outputting, by the operation server, source information for outputting a processed widget on a preview screen and a webpage of the widget generated by processing the content, based on an input of the product provider device on the widget generation editing tool; and
providing, by the operation server, the output source information to the product provider device.

2. The method of claim 1, wherein the review information further comprises at least one of video information and comment information written for the product by the persons to experience the product.

3. The method of claim 1, further comprising:
posting the configured content of the persons to experience the product online.

4. The method of claim 3, further comprising:
determining the person to experience the product, who obtains the much feedback information, among the persons to experience the product as the best person to experience the product,
wherein the posting of the content of the persons to experience the product comprises:
posting content of the best person to experience the product to be distinguished from content of persons to experience the product except for the best person to experience the product.

5. The method of claim 3, further comprising:
outputting at least one billing item for the product on the content of the persons to experience the product;
counting the number of times of operations requested through the at least one billing item; and
calculating billing for the product based on the counted number of times.

6. The method of claim 5, wherein the at least one billing item comprises a sales site link item for the product and an SNS link item used for the product by the persons to experience the product, and
wherein an operation requested through the at least one billing time comprises at least one of:
clicking on the sales site link item or the SNS link item;
completing a subscription to a sales site linked through the sales site link item;
purchasing the product on the sales site linked through the sales site link item; and
verifying the photo information and the hashtag information shared by the persons to experience the product through the SNS link item.

7. The method of claim 3, further comprising:
after the time period is ended, configuring a result report based on at least one of information received from the SNS server in connection with the product and information stored in the operation server with respect to the product; and
providing the configured result report to a product provider device of a provider who provides the product.

8. A method for selling a product based on an SNS activity of a product purchaser, the method comprising:
receiving, by an operation server, discount price information generated by subtracting an SNS advertising price information value calculated as an SNS advertising cost from consumer price information for the product from a product provider device;
posting, by the operation server, information about the product including the discount price information online;
receiving, by the operation server, an application for purchasing the product via a user device of each of at least one or more users from the at least one or more users who register SNS interworking information for interworking with at least one SNS server in the operation server;
if a purchase amount corresponding to the discount price information is paid from the user, paying, by the operation server, a sale amount in which a fee for each product is excepted from the purchase amount to a product provider;
providing, by the operation server, the product to a user who pays the sale amount and requesting, by the operation server, the user device to share review information associated with the product with another user on an SNS server in which the user is registered, the review information including hashtag information associated with the product and photo information including the product;
receiving, by the operation server, SNS activity information collected from the SNS server during a time period with respect to the review information from the SNS server;
configuring, by the operation server, content of persons to experience the product based on at least one of the review information, SNS activity information of the persons to experience the product, and user information of persons to experience the product, the user information being registered in the operation server;
outputting, by the operation server, a widget generation editing tool for generating a widget through a product provider device based on the configured content;
generating and outputting, by the operation server, source information for outputting a processed widget on a preview screen and a webpage of the widget generated by processing the content, based on an input of the product provider device on the widget generation editing tool; and
providing, by the operation server, the output source information to the product provider device.

9. The method of claim 8, further comprising:
registering review information to be shared on an SNS in the operation server.

10. The method of claim 9, wherein the registering of the review information in the operation server comprises:
providing an editing tool for registering review information to be registered in the SNS server in the operation server and simultaneously registering the review information in the SNS server; and
if the user registers the review information through the editing tool, registering the review information in both of the operation server and the SNS server.

11. The method of claim 8, further comprising:
posting the configured content of the users online.

12. The method of claim 8, wherein the review information further comprises at least one of video information and comment information written for the product by the user.

13. The method of claim 8, wherein the hashtag information comprises at least one of brand information of the product, product name information of the product, hashtag information associated with the operation server, and tag information written by the user in connection with the product.

14. The method of claim 8, wherein the requesting comprises:
requesting the user device to share the review information or provider site link information about the product on an SNS server, in which the user is registered, during a time period or more.

15. The method of claim 8, further comprising:
outputting a follow application menu for interesting and registering a brand associated with the product online; and
if a request to follow the brand is received from the user through the follow application menu, providing recent news information of the followed brand to the user device.

16. The method of claim 8, further comprising:
if the user does not share the review information associated with the product with the other user on the SNS server, transmitting a warning message to the user device or adding a penalty by managing the user on a blacklist.
